(19) United States
(12) Patent Application Publication
(10) Pub. No.: US 2022/0078968 A1
(43) Pub. Date: Mar. 17, 2022

(54) MATERIAL SPREADER

(71) Applicant: AOB Products Company, Columbia, MO (US)

(72) Inventors: Aaron Wood, Columbia, MO (US); Timothy S. Kinney, Warrenton, MO (US); James Tayon, Moberly, MO (US); Seth Wheeler, Columbia, MO (US); Ryan Varnum, Columbia, MO (US); Matthew Kinamore, Columbia, MO (US); Curtis Smith, Columbia, MO (US)

(21) Appl. No.: 17/444,282

(22) Filed: Aug. 2, 2021

Related U.S. Application Data
(60) Provisional application No. 63/059,379, filed on Jul. 31, 2020.
(60) Provisional application No. 63/179,867, filed on Apr. 26, 2021.

(51) Int. Cl. A01C 17/00

(52) U.S. Cl. CPC A01C 17/008; A01C 17/005

(57) ABSTRACT

A broadcast spreader, components thereof, and associated methods. The broadcast spreader includes a hopper, a spinner, a motor for turning the spinner, and a material feeder configured to feed granular material from the hopper to the spinner. The broadcast spreader includes a material feeder adjustment actuator, a spinner speed control actuator, and a motor on/off actuator. A harness wearable by a person is configured to carry the broadcast spreader. A kit of interchangeable battery adaptors enables use of different brands or models of batteries.

### CROSS-REFERENCE TO RELATED APPLICATION

The present application claims priority to U.S. Provisional Application Nos. 63/059,379, filed Jul. 31, 2020, and 63/179,867, filed Apr. 26, 2021, each of which is hereby incorporated by reference in its entirety.

### FIELD

The present disclosure generally relates to battery powered tools or other types of tools, and more particularly to material spreaders or broadcasters.

### BACKGROUND

Material spreaders are used for various purposes. Most spreaders have a hopper that is filled with granular material. The granular material is delivered from the hopper to a rotating wheel that disperses the material over an area.

### SUMMARY

In one aspect, a broadcast spreader for spreading granular material comprises a frame and a hopper supported by the frame. The hopper is configured to hold the granular material. The broadcast spreader comprises a spinner supported by the frame and configured to turn about a spinning axis for spreading the granular material from the hopper. A material feeder supported by the frame is configured to feed the granular material from the hopper to the spinner. A feed rate actuator supported by the frame is configured to adjust the material feeder to change a rate at which the granular material is fed from the hopper to the spinner. The feed rate actuator is rotatable about an actuation axis different from the spinning axis to change the rate at which granular material is fed from the hopper to the spinner.

In another aspect, a broadcast spreader is configured to be carried by a person during operation of the spreader to spread granular material. The broadcast spreader comprises a hopper configured to hold the granular material. The broadcast spreader comprises a spinner configured to turn for spreading the granular material from the hopper. The broadcast spreader comprises a material feeder configured to feed the granular material from the hopper to the spinner. A motor is operatively connected to the spinner to turn the spinner for spreading the granular material. An on/off actuator is configured to selectively turn the motor on and off. The broadcast spreader includes a spinner speed control actuator separate from the on/off actuator. The spinner speed control actuator is configured to be manipulated by hand by the person to adjust operation of the motor to adjust a speed at which the spinner spins.

In yet another aspect, a broadcast spreader system is for use by a person to spread granular material. The system comprises a broadcast spreader and a harness. The broadcast spreader comprises a frame and a hopper supported by the frame. The hopper is configured to hold the granular material. The broadcast spreader includes a spinner supported by the frame and configured to turn for spreading the granular material from the hopper. The broadcast spreader comprises a material feeder supported by the frame and configured to feed the granular material from the hopper to the spinner. The broadcast spreader comprises a first harness connector supported by the frame. The harness is wearable by the person. The harness includes a first shoulder strap and a second shoulder strap. The first and second shoulder straps are configured to be received over left and right shoulders, respectively, of the person when the harness is worn by the person. The harness includes a front web to which the first and second shoulder straps are operatively connected. The harness includes a first spreader connector on the front web configured to form a first releasable connection with the first harness connector for the harness to carry the spreader.

Other objects and features of the present disclosure will be in part apparent and in part pointed out herein.

### BRIEF DESCRIPTION OF THE DRAWINGS

FIG. 1 is a left, front perspective of a broadcast spreader of the present disclosure;

FIG. 2 is a right, front perspective of the broadcast spreader;

FIG. 3 is a rear perspective of the broadcast spreader;

FIG. 4 is a fragmentary section of the broadcast spreader taken in a plane including line 4-4 of FIG. 2;

FIG. 5 is a fragmentary perspective of a portion of a user interface of the broadcast spreader;

FIG. 6 is a fragmentary bottom perspective of a material feeder and associated driver;

FIG. 7 is a top perspective of the material feeder and driver;

FIG. 8 is a perspective of a flow restrictor of the material feeder;

FIG. 9 is a perspective of a feed gate of the material feeder and an associated rack;

FIG. 10 is a top view of the feed gate and rack;

FIG. 11 is a bottom perspective of the feed gate in a first open configuration;

FIG. 12 is a bottom perspective similar to FIG. 11 but showing the feed gate in a second open configuration;

FIG. 13 is a bottom perspective similar to FIG. 11 but showing the feed gate in a third open configuration;

FIG. 14 is a bottom perspective similar to FIG. 11 but showing the feed gate in a fourth open configuration;

FIG. 15 is a perspective of a spinner of the broadcast spreader;

FIG. 16 is a top view of the spinner;

FIG. 17 is a section of the spinner taken in a plane including line 17-17 of FIG. 16;

FIG. 18 is a fragmentary perspective of an on/off actuator of the broadcast spreader;

FIG. 19 is a fragmentary perspective section of the broadcast spreader showing details of the on/off actuator;

FIG. 20 is a schematic of a control system of the broadcast spreader;

FIG. 21 is an exploded fragmentary perspective of a battery compartment of the spreader with associated battery adapter and battery;

FIG. 22 is a fragmentary perspective of the battery compartment;

FIG. 23 is a fragmentary perspective of the battery compartment having the battery adapter and battery installed therein;

FIG. 24 is a top fragmentary perspective of the battery compartment having the battery adapter and battery installed therein;

FIG. 25 is a fragmentary section of the battery compartment, battery adapter, and battery;

FIG. 26 is a bottom, rear perspective of the battery adapter;

FIG. 27 is a bottom, front perspective of the battery adapter;

FIG. 28 is a top, front perspective of the battery adapter;

FIG. 29 is a front, bottom perspective of a second battery adapter;

FIG. 30 is a rear, bottom perspective of the second battery adapter;

FIG. 31 is a perspective of a kit of battery adapters having different docking structures for mounting different batteries thereon;

FIG. 32 is a perspective of a person wearing a harness on which the broadcast spreader is mounted;

FIG. 33 is a perspective of the person wearing the harness with the broadcast spreader removed therefrom;

FIG. 34 is a front perspective of the person wearing the harness;

FIG. 35 is a left perspective of the person wearing the harness, with a connection thereof being made;

FIG. 36 is a rear perspective of the person wearing the harness;

FIG. 37 is a perspective of a material feeder of another embodiment of a broadcast spreader; and

FIG. 38 is a schematic of a control system of the broadcast spreader of FIG. 37.

Corresponding reference characters indicate corresponding parts throughout the drawings.

### DETAILED DESCRIPTION

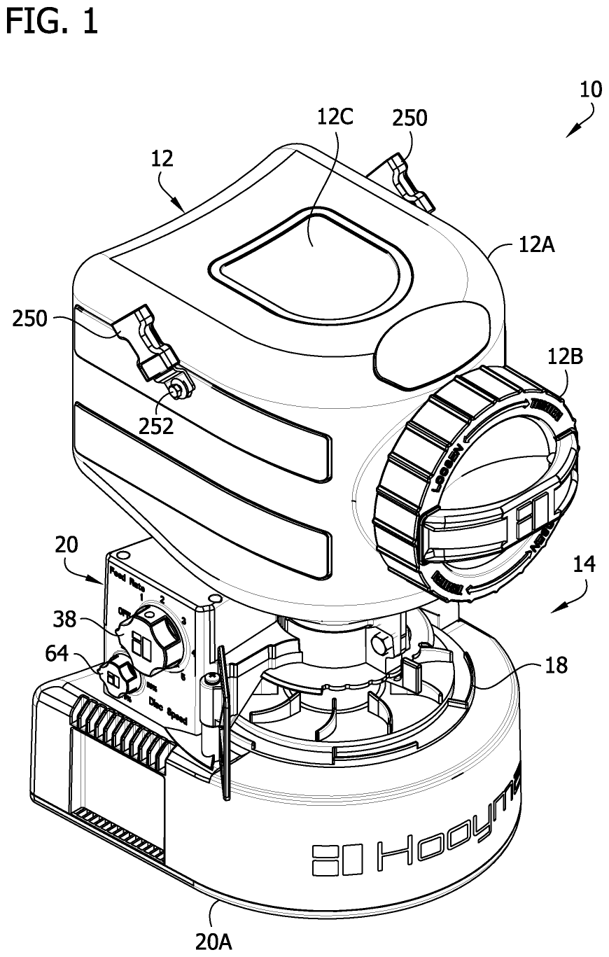

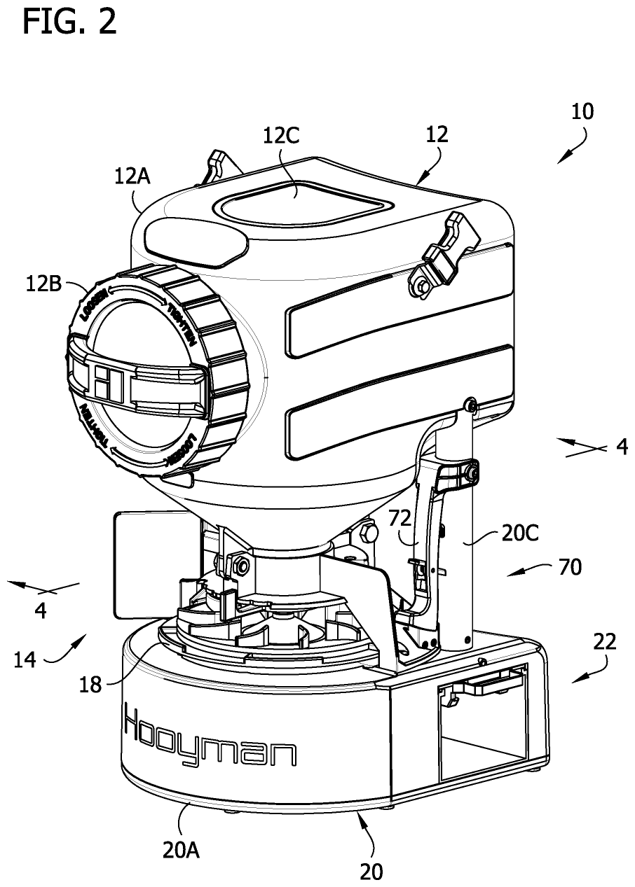

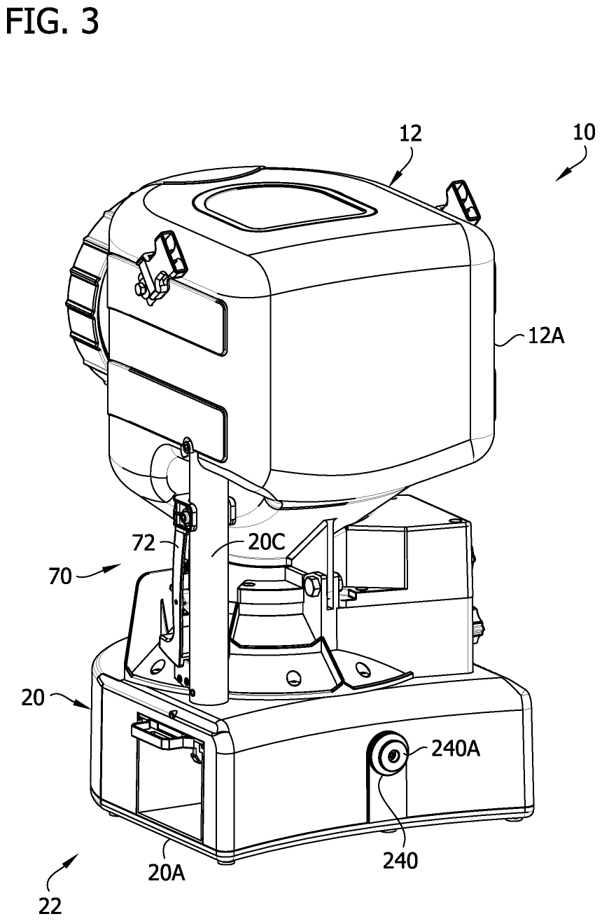

Referring to FIGS. 1-3, a material spreader or broadcaster (broadly, “tool”) of the present disclosure is indicated generally by the reference number 10. The spreader can be used for spreading various types of material, such as granular material. For example, the spreader 10 may be used to spread seed (e.g., grass, clover, soybean, corn, turnip, or other seed), fertilizer, herbicide, insecticide, and/or salt, etc. In the disclosed embodiment, the spreader 10 is configured to be carried by a human over an area to spread the granular material over the area. Moreover, the spreader 10 is configured to operate using battery power while the user carries the spreader. However, it will be understood that the spreader 10 could be configured to be carried by a vehicle and/or be manually powered (e.g., hand crank) without departing from the scope of the present disclosure. Moreover, other types of tools could embody aspects of the present disclosure without departing from the scope of the present invention.

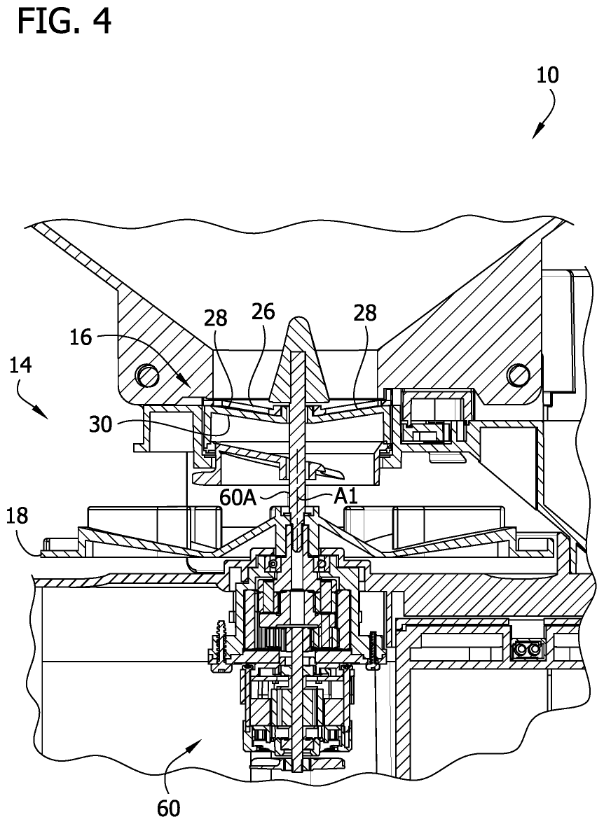

Referring to FIG. 1, the spreader 10 includes a hopper 12 and a spreading mechanism 14. The hopper 12 is configured to hold material to be spread by the spreader 10. The spreading mechanism 14 receives material from the hopper 12 and disperses the material (e.g., to fall to the ground below the spreader). The spreading mechanism 14 includes a material feeder and a material distributor. As explained in further detail below, the material feeder comprises a feed valve 16, and the material distributer comprises a spinner 18 that receives material from the hopper 12 via the feed valve. As the spinner 18 spins about a spinning axis A1 (FIG. 4), material is flung outward from the spinner in front of, to the left of, and/or to the right of the spreader 10 in a broadcasting swath. The user manipulates operation of the spreader 10 via a user interface including a variety of actuators (broadly, collectively, “user input”), as explained in further detail below.

The hopper includes a container 12A and a lid 12B. The lid 12B is configured to releasably thread onto a threaded collar around a material fill opening in the container 12A. To fill the hopper 12 with material, the spreader 10 can be laid on its back to orient the fill opening upward. The lid 12B is removed, and material is poured into the container 12A. The lid 12B is then threaded back onto the container 12A to cover the opening.

The container 12A can be formed of blow-molded plastic (or other suitable material or forming process), and can be formed of opaque material (e.g., non-transparent or non-translucent, colored plastic). The hopper 12 includes a window 12C covering an opening in the top of the container 12A. For example, the window 12C can be made of clear or transparent plastic to enable a user to see through the window to observe material in the hopper 12 (e.g., when the spreader is carried by the user). The window 12C can be connected to the container 12A by fasteners (e.g., screws, rivets, etc.) or in another suitable manner. The container 12A and window 12C form a body of the hopper bounding an interior in which the material to be spread is receivable.

The spreader 10 includes a frame 20 that defines a housing and/or support for various components of the spreader. The frame 20 includes a base 20A having a bottom configured to rest on a horizontal support surface. The base includes a battery compartment 22, discussed in further detail below, for receiving a battery to power the spreader. The hopper 12 is connected to and supported by the frame 20 above a spinner recess in the frame 20 in which the spinner 18 is mounted for receiving material from the hopper. The material feeder 16 is connected to the frame 20 below the hopper 12 above the spinner recess.

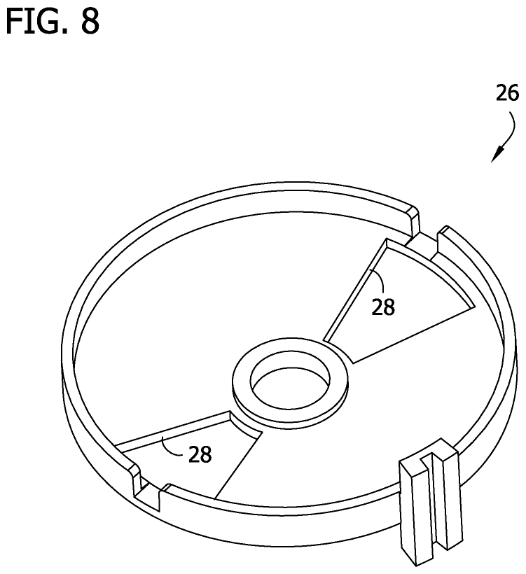

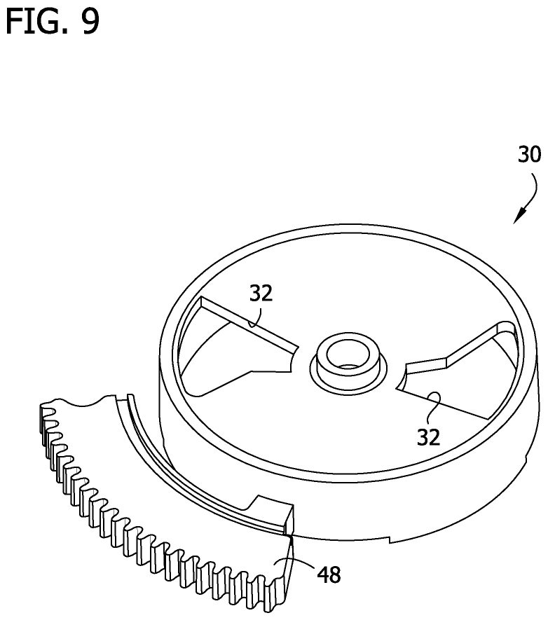

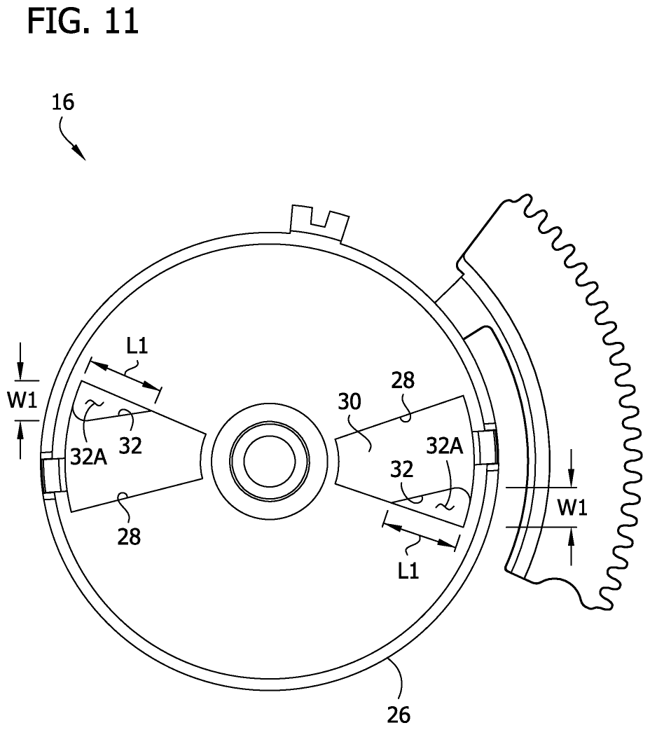

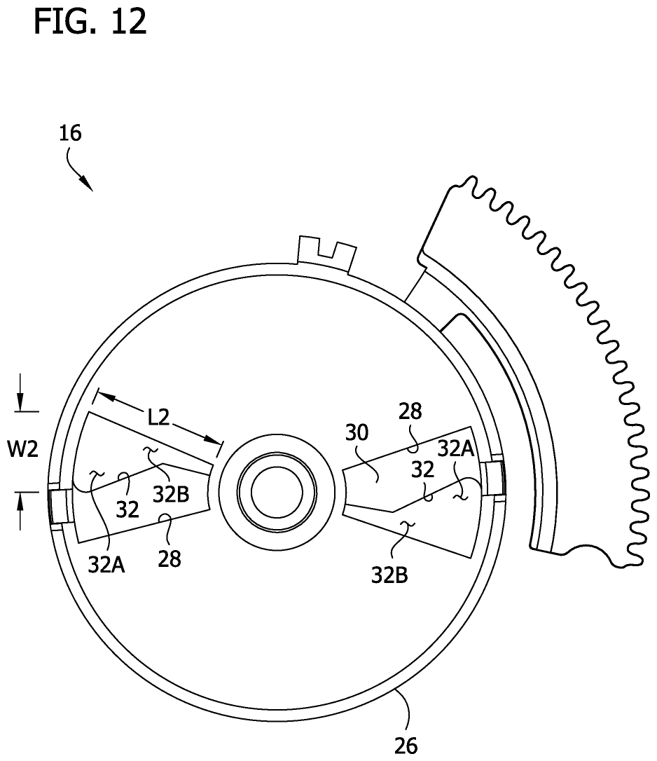

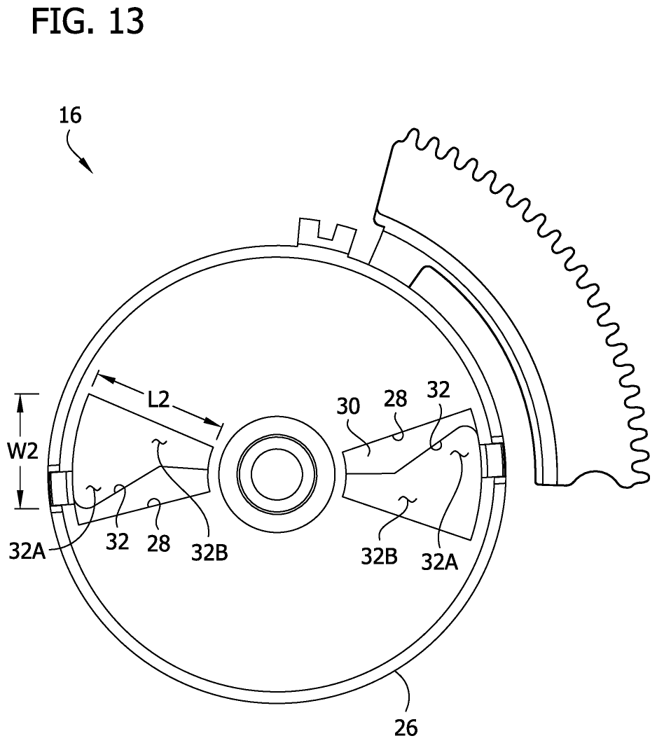

Referring to FIGS. 4, 7, and 8, the material feeder 16 includes a material flow restrictor 26 that bounds a bottom of the hopper interior. The material flow restrictor 26 is received in an opening in the frame 20 above the spinner 18. The material flow restrictor 26 includes two feed outlets 28 through which material can exit the hopper 12 to be received by the spinner 18. The material feeder 16 also includes a feed gate 30 below the material flow restrictor 26. The material flow restrictor 26 and feed gate 30 form the feed valve 16. The feed gate 30 has two feed openings 32. Each feed opening 32 corresponds to a respective one of the feed outlets 28. The flow restrictor 26 is connected to the frame 20 to be stationary, and the feed gate 30 is movable with respect to the flow restrictor to selectively arrange the feed openings 32 out of registration with and in registration with the respective feed outlets 28. In the illustrated embodiment, the feed gate 30 is pivotable about the spinning axis A1 to move the feed openings 32 with respect to the feed outlets 28 between a closed position and a plurality of open positions, such as shown by comparison of FIGS. 11-14.

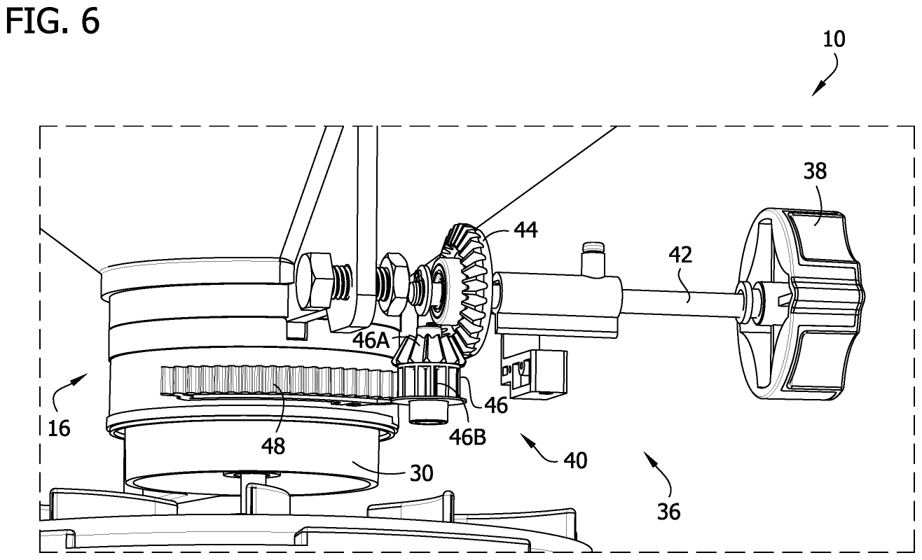

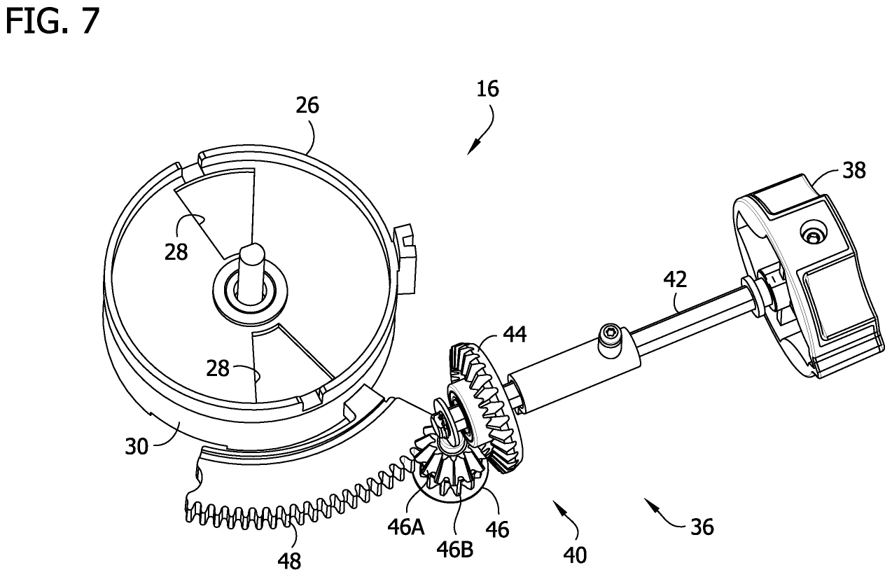

Referring to FIGS. 6 and 7, the spreader 10 includes a feed gate driver 36 configured to drive movement of the feed gate 30 to selectively open and close the feed valve 16. The feed gate driver 36 includes an actuator 38 and a linkage operatively connecting the actuator to the feed gate. In the illustrated embodiment, the actuator 38 comprises a rotatable knob (broadly, “dial”), and the linkage comprises a gear drive train 40. The knob 38 is mounted on and rotatable conjointly with a shaft 42 about its longitudinal axis A2. Rotation of the shaft 42 via the knob 38 causes conjoint rotation of a drive gear 44 on the other end of the shaft. The drive gear 44 drives pivoting of the feed gate 30 via a driven gear 46 and a rack 48. The driven gear 46 includes a first set of teeth 46A in mesh with the drive gear 44, and a second set of teeth 46B in mesh with the rack 48. The rack 48 is connected to the feed gate 30 such that the feed gate and rack pivot conjointly. The arrangement is such that rotation of the knob 38 in a clockwise direction moves the feed openings 32 to tend to open the feed valve 16, and rotation of the knob in a counter-clockwise direction moves the feed openings to tend to close the feed valve.

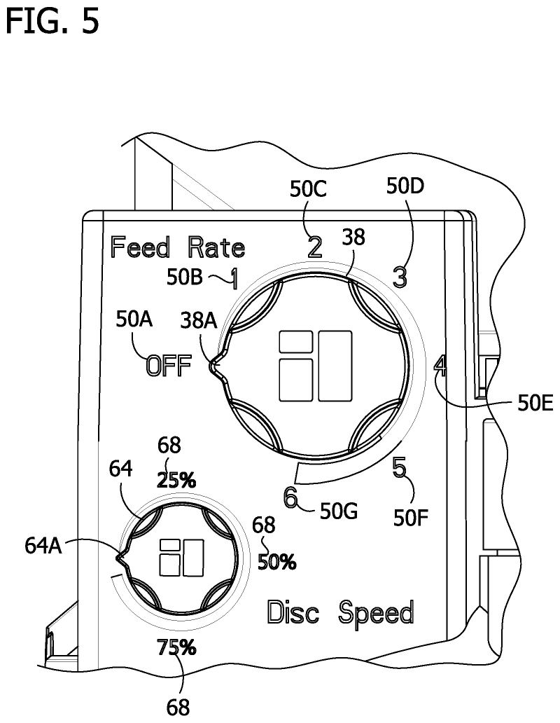

Referring to FIG. 5, the knob 38 includes an indicator 38A (e.g., an arrow) that the user can reference with respect to indicia 50A-50G (e.g., a set of numbers) on the frame 20 representative of a feed rate corresponding to the degree of openness of the feed gate 16. For example, when the user turns the knob 38 by hand so the indicator 38A is oriented to point to the feed rate indicia “1”, the feed rate will be less than the feed rate when the indicator is oriented to point to the feed rate indicia “5”. When the indicator 38A is oriented to point to the feed rate indicia “OFF”, the feed valve 16 is closed. Other types of linkages (e.g., other types of drive trains), and other types of actuators (e.g., pivotable lever), can be used without departing from the scope of the present disclosure.

It will be appreciated that granular materials of different types have granules having different sizes and/or may flow out of the hopper 12 more easily. For example, clover seed is very small and tends to flow at a high rate out of a small flow opening. On the other hand, corn seed is larger and requires a much larger opening to flow at such a high rate out of the hopper. Turnip seed is another example of a very small seed, and turnip plants (e.g., in a wildlife food plot) do not grow well when too much seed is spread, creating an overpopulation of turnip plants. The material feeder 16 is configured to facilitate fine control of small seed feed rate (e.g., for turnip and clover seed), and also to provide fine control of medium and large seed feed rates (e.g., cereal rye, soybeans, corn).

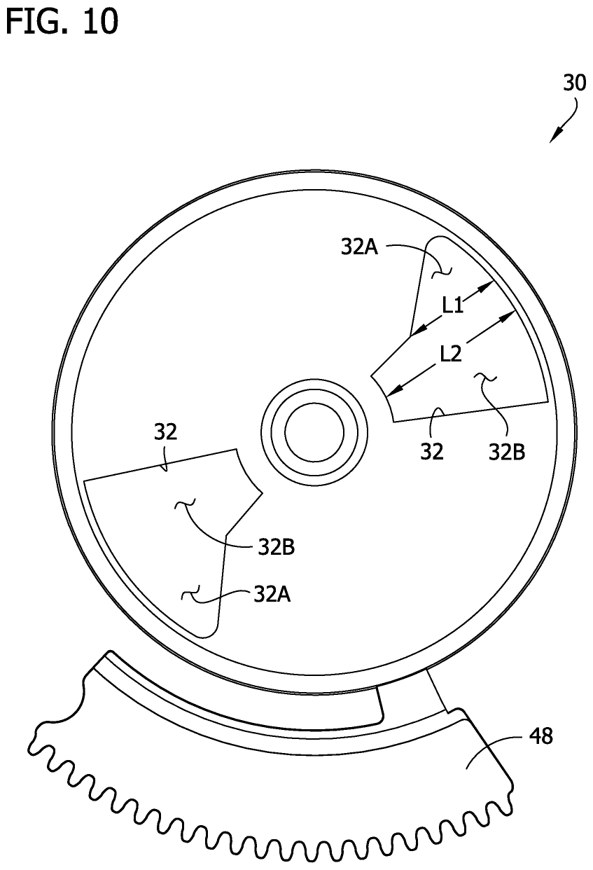

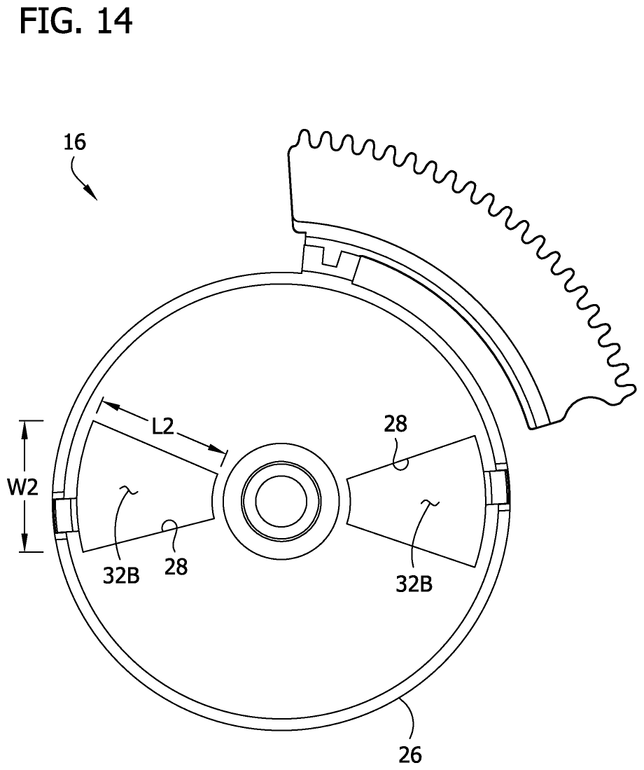

Referring to FIG. 10, each feed opening 32 is asymmetrical and includes a first region 32A and a second region 32B. The first region 32A is a generally triangular region and is smaller (lesser width and length) than the second region 32B, which has a generally truncated pie piece shape. The first region 32A may be used for metering smaller seeds. As the feed gate 30 rotates (e.g., from the closed position “0” toward the open position “10” via turning of the knob), the feed openings 32 begin to open by moving into registration with the respective feed outlets 28. In a first range of motion of the feed gate 30 (e.g., corresponding to the range of feed rate indicia “OFF” to “3”), the first region 32A moves into registration with the feed outlet 28 to provide fine feed rate control for small seeds. For example, if the actuator 38 is turned to position “3” corresponding to FIG. 11, the first regions 32A of the feed openings 32 are fully open. Clover seed or turnip seed might be seeded in the first range of motion between “OFF” and “3”. In a second range of motion of the feed gate 16 (e.g., corresponding to the range of feed rate indicia “4” to “10”), the second region 32B moves into registration with the feed outlet 28 to provide fine feed rate control for medium and large seeds (e.g., cereal rye, soybeans, corn, etc.). As the feed gate 16 is rotated to open more (e.g., to open positions “5”, “8”, etc.), the openness of the feed gate increases as the larger second region 32B of the feed opening moves more into registration with the feed outlets. In open position “10” (e.g., FIG. 14), the triangular first regions 32A of the feed openings 32 are out of registration with the feed outlets 28, and the larger second regions 32B of the feed openings are fully in registration with the feed outlets. The arrangement is such that small granule material (e.g., clover or turnip seeds) can be better metered through adjustment of the feed gate 16 across the initial, smaller triangular regions 32A of the feed openings 32 (e.g., in open positions “1” to “3”), and larger granule material (e.g., larger seeds) can be metered through the smaller regions 32A and the larger regions 32B of the feed openings (e.g., in open positions “4” to “10”).

Referring to FIG. 10, in one aspect, a leading edge of the feed opening has an irregular shape, with a first edge segment 32C that deviates from a second edge segment 32D. The first edge segment 32C extends in a direction nonparallel to a direction in which the second edge segment extends 32D. The first edge segment 32C bounds a portion of the first region 32A, and the second edge segment 32D bounds a portion of the second region 32B. In another aspect, the leading edge of the feed opening 32 is configured such that as the feed opening is moved in the first range of movement (e.g., corresponding to the range of feed rate indicia “OFF” to “3) to increase a width W1 (extending generally in direction of movement of feed opening) of the registered feed opening and feed outlet 28, a length L1 of the registered feed opening and feed outlet increases as well. However, the leading edge of the feed opening 32 is configured such that as the feed opening is moved in the second range of movement (e.g., corresponding to the range of feed rate indicia “4” to “10”) to further increase the width W2 of the registered feed opening and feed outlet 28, the length L2 of the registered feed opening and feed outlet remains constant. In the first range of motion of the feed gate, the registered feed and outlet openings 32, 28 have a maximum length L1 less than the maximum length L2 of the registered feed and outlet openings in the second range of motion. The arrangement facilitates finer metering of small granules (e.g., small seeds) in the first range of motion. Other configurations can be used without departing from the scope of the present disclosure.

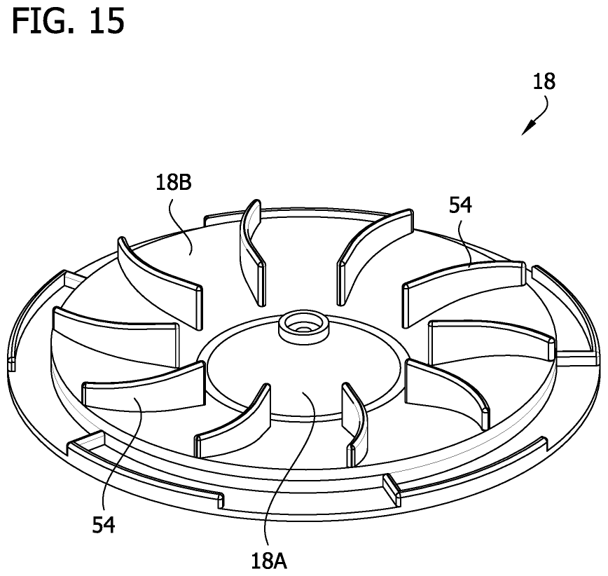

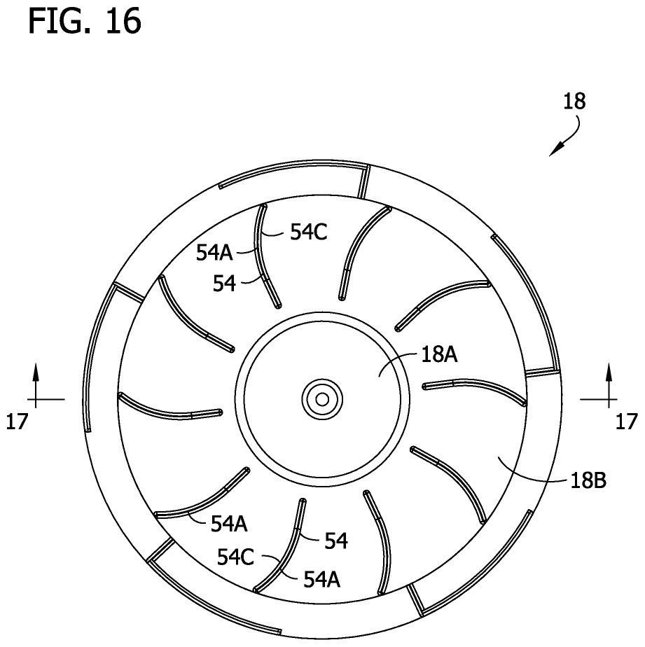

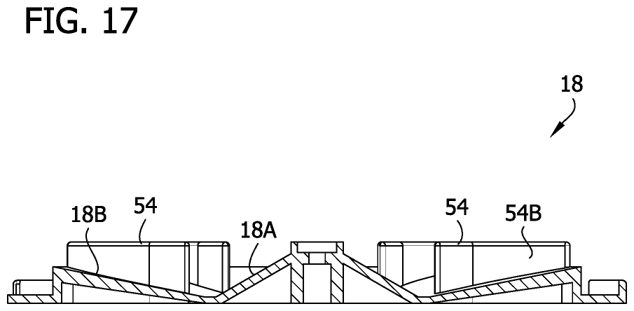

Referring to FIGS. 15-17, the spinner 18 is shown in closer detail. The spinner is generally disc shaped and has a first annular portion 18A sloped downward to promote disbursement of the granular material away from a center of the spinner. The spinner 18 includes a second annular portion 18B outward from the first portion that is sloped upward to promote ramping of the granular material upward to increase throw of the seed away from the spinner. The spinner 18 includes a plurality of fins 54 on the second portion 18B. The fins extend outward away from the center of the spinner 18 and are arranged to fling the seed outward as the spinner turns. In the disclosed embodiment, the fins 54 extend generally radially away from the center of the spinner and include outboard arcuate segments 54A. The disclosed fins have concave throwing surfaces 54B arranged to engage the granular material to throw the material away from the spinner. The arrangement is such that as a granule moves outward along a fin 54, the granule is accelerated to leave the spinner at a greater speed than if the fins were straight or planar radiating away from the center of the spinner.

Referring to FIG. 4, the spreader includes a motor 60 including an output shaft 60A rotatable about the axis A1 to spin the spinner. Thus, the spinner 18 is powered by the motor 60 for broadcasting material from the hopper 12. It will be appreciated that the motor could be omitted, and the spreader could be manually operated (e.g., hand crank), without departing from the scope of the present disclosure.

Referring to FIG. 5, the spreader includes a spinner speed control actuator 64 configured to permit the user to select a speed at which the spinner 18 spins. In the illustrated embodiment, the spinner speed control actuator 64 comprises a knob (broadly, “dial”) that can be turned by the hand of the user. As explained in further detail below, the spinner speed control knob 64 is operatively connected via a potentiometer 66 to the motor 60 to control the speed at which the motor rotates the output shaft 60A and thus speed at which the spinner 18 spins. The knob 64 includes an indicator 64A (e.g., an arrow) that the user can reference with respect to indicia 68 (e.g., a set of numbers) on the frame representative of a speed of the spinner 18 with respect to a maximum (e.g., 25%, 50%, 75%, etc.). For example, when the indicator 64A is oriented to point to the indicia 50%, the spinner will spin at 50% of its maximum spin speed. By adjusting the speed of the spinner 18, such as manipulating the actuator 64 by hand, the user can adjust how far the granular material is thrown away from the spinner 18. In this embodiment, the actuator 64 does not turn the motor on/off. Other types of actuators (e.g., pivotable lever), can be used without departing from the scope of the present disclosure.

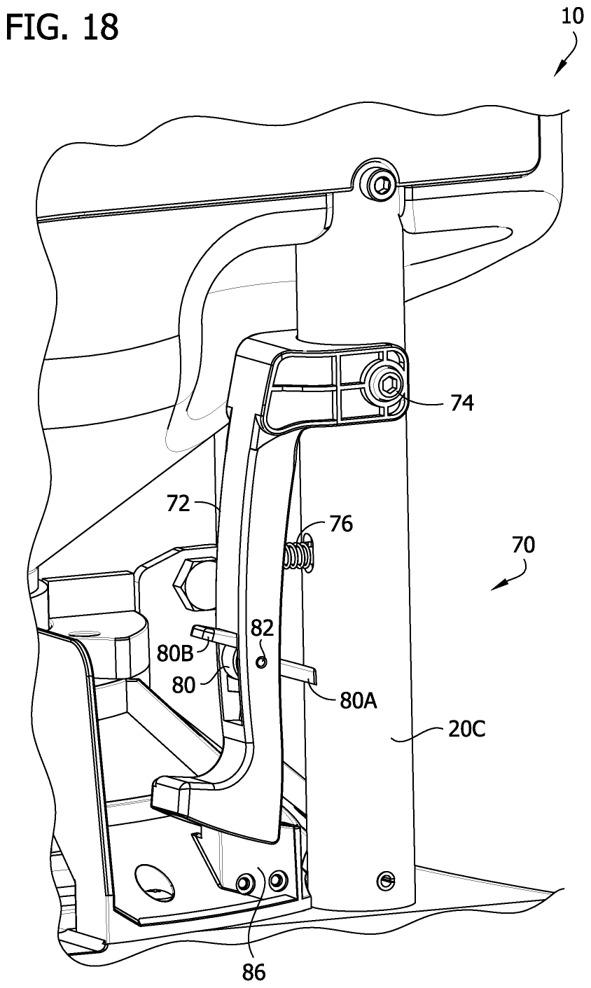

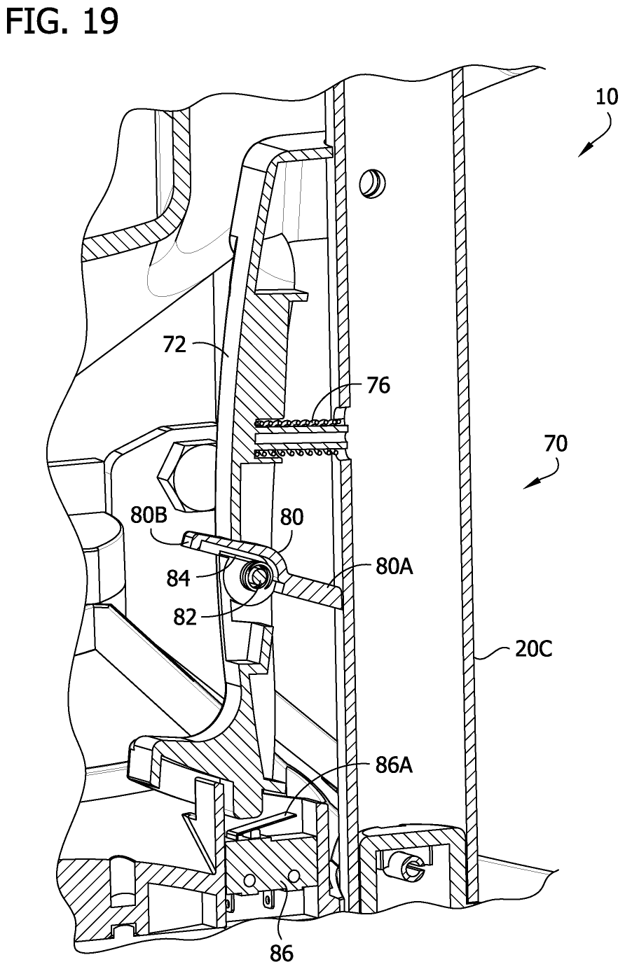

Referring to FIGS. 18 and 19, the spreader 10 includes a power actuator 70 (broadly, “on/off actuator”) to turn the motor 60 on/off to selectively rotate the spinner 18. The actuator 70 is configured to require a two-stage manipulation of the actuator to turn on the motor 60. The actuator 70 includes a first lever 72 pivotably connected by a fastener 74 to a post 20C of the frame 20. The actuator 70 includes a spring 76 between the post 20C and first lever 72 that biases the first lever away from the post. The actuator 70 includes a second lever 80 (broadly, “safety”), that in a safety position (e.g., FIGS. 18, 19) obstructs movement of the lever 72 toward the post 20C in an actuating direction. The second lever 80 includes a first arm 80A (broadly, “stop”) and a second arm 80B (broadly, “release”). The second lever 80 is pivotably mounted to the first lever by a pin 82. The second lever 80 is biased by a torsion spring 84 to a safety configuration in which the second lever obstructs actuation of the first lever 72. In the safety configuration, the first arm 80A engages the post 20C, and the second arm 80B protrudes forward in front of the first lever 72. The second lever 80 can be moved from the safety configuration to a released configuration by the user engaging the second arm 80B with their hand (e.g., with one or more fingers) and pivoting the second lever against the bias of the torsion spring 84 to move the first arm out of blocking arrangement with respect to the post 20C. This can be done via a downward motion of the user's hand in engagement with the second lever 80. When the lever 72 is moved toward the post 20C, the lever engages an arm 86A of an electronic switch 86 and closes the switch, which causes the motor 60 to turn on. When the lever 72 is released, the spring 76 causes the first lever to return to its off position, the motor 60 turns off, and the spring 84 causes the second lever to return to its safety position.

It will be appreciated that the post 20C and first lever 72 form a handle that the user grabs with their hand while operating the spreader. For example, the user may position a palm of their left hand against a back side of the post 20C, wrap their fingers around the lever 72, move one or more of the fingers downward to release the safety 80, and then squeeze the first lever to compress the spring 76 and move the first lever from its “off” position to its “on” position. The lever 72 is sized to receive the user's four fingers thereon when they are wrapped around the lever and post 20C. This provides an ergonomic grip for the user, and permits the user to maintain the first lever 72 in the “on” position using their full hand, instead of, for example, a single finger. This increases comfort of the user, especially when operating the spreader 10 for an extended time. This also permits the user to comfortably stabilize the spreader 10 while they are carrying the spreader on their chest, as explained in further detail below.

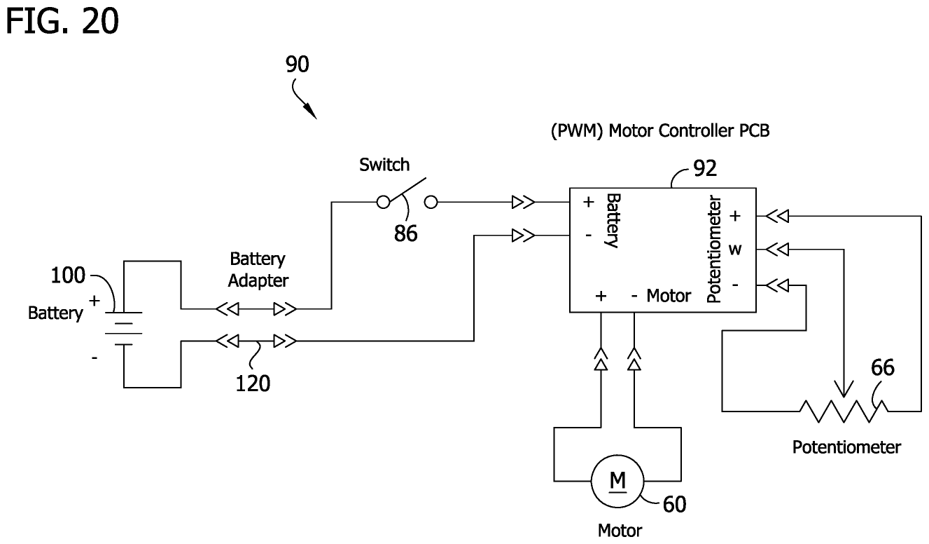

Referring to FIG. 20, the spreader 10 includes a control system generally indicated by 90. The control system includes a spreader motor controller 92 (e.g., printed circuit board) including a pulse width modulator. The potentiometer 66 associated with the spinner speed actuator 64 is operatively connected to the spreader motor controller 92. The motor 60 is operatively connected to the spreader motor controller 92 to receive electrical power from the battery 100. The on/off switch 86 is configured to close a circuit operatively connecting the battery 100 to the spreader motor controller 92. When the on/off switch 86 is closed (i.e., when the first lever 72 is in the “on” position), electrical power from the battery 100 is provided to the motor 60 according to a setting of the spinner speed control actuator 64. The spreader motor controller 92 controls a duty cycle of the motor 60 to cause the spinner 18 to spin slower or faster, based on the setting of the potentiometer 66. As the duty cycle increases, more voltage is applied to the motor 60, resulting in increased RPM of the spinner 18. Other configurations can be used without departing from the scope of the present disclosure.

It will be appreciated that in the disclosed embodiment the motor power actuator 70 is separate from the spinner speed actuator 64 such that the motor 60 is turned on/off independently from adjusting the speed of the motor. Accordingly, the user can set a speed of the spinner 18 via the spinner speed actuator 64, and that setting will be maintained as the motor is repeatedly turned on/off. For example, the user may need to stop operation of the spreader 10 to refill with more seed, and when the user begins operation of the spreader again by actuating the motor power actuator 70, the spinner speed will be the same as the user had been using previously (assuming the spinner speed actuator has not been adjusted). Moreover, in this embodiment, the motor on/off actuator 70 and the feed gate actuator 38 are separate, such that the motor 60 can be turned on/off independent from actuation of the feed gate 16. Other configurations can be used without departing from the scope of the present disclosure.

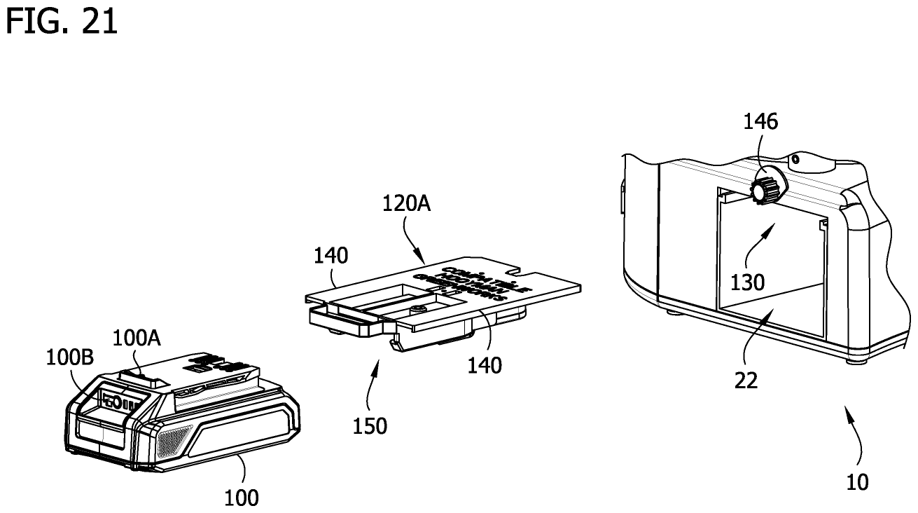

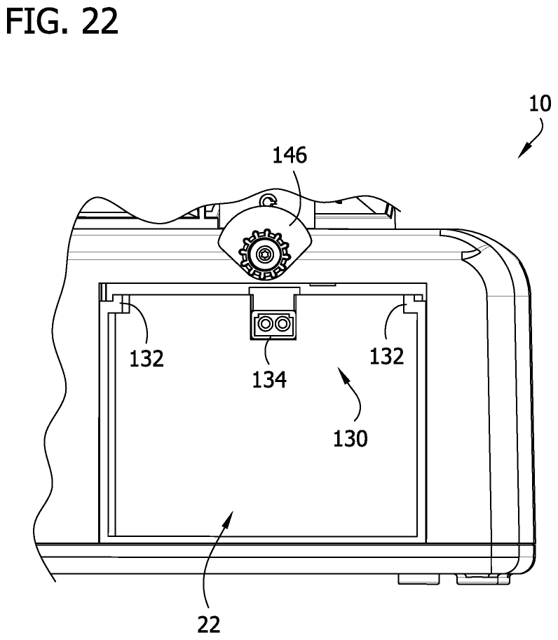

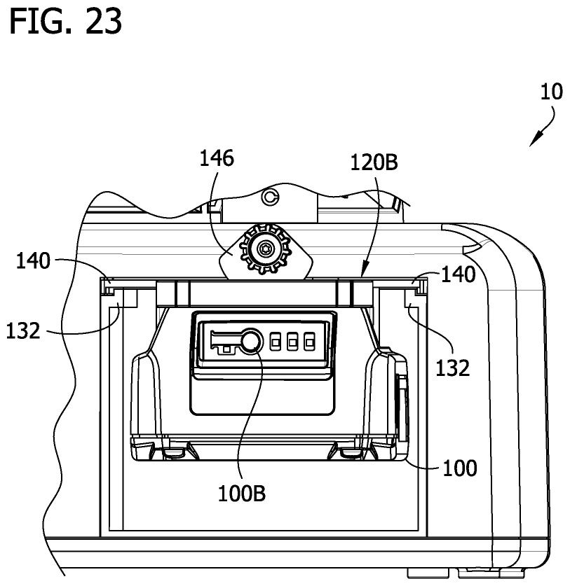

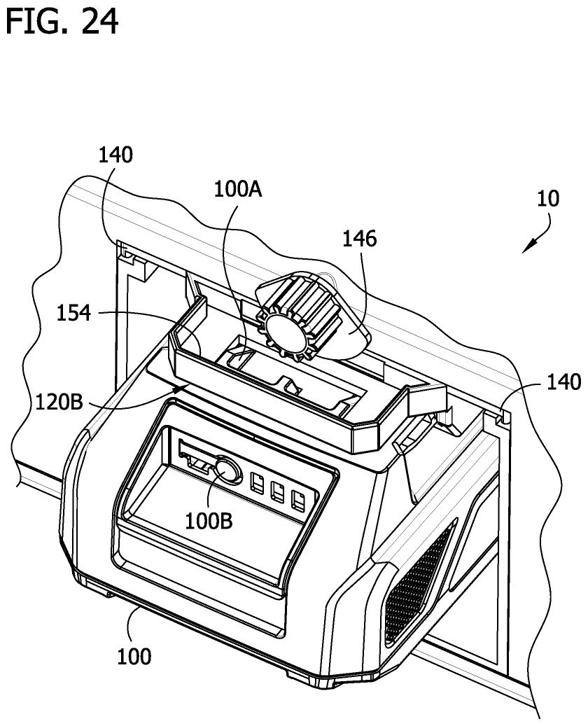

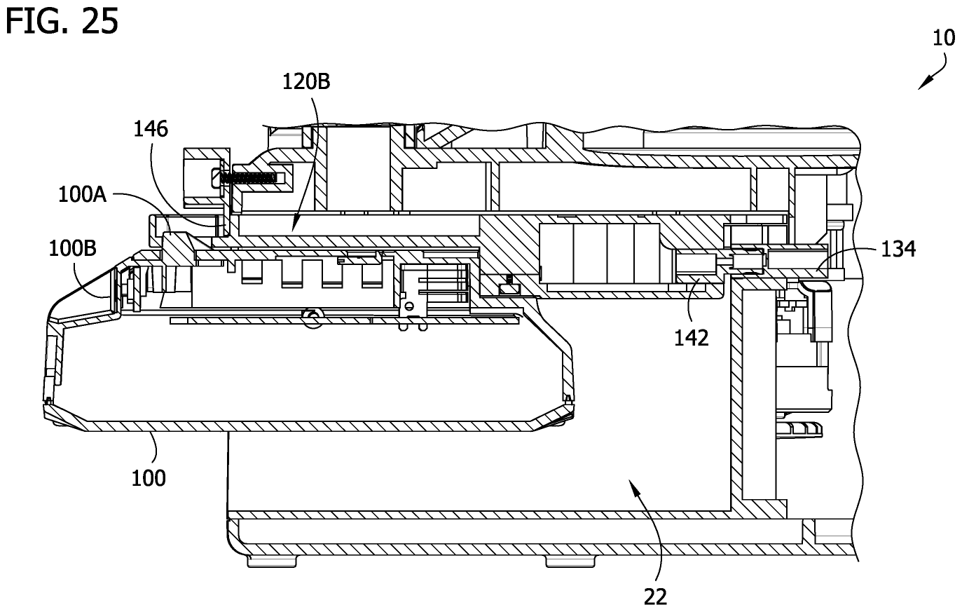

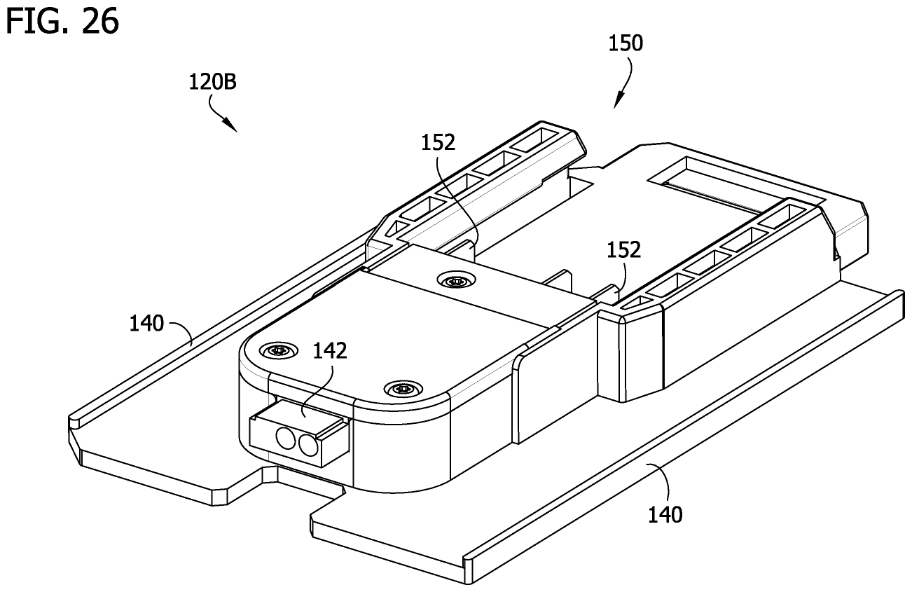

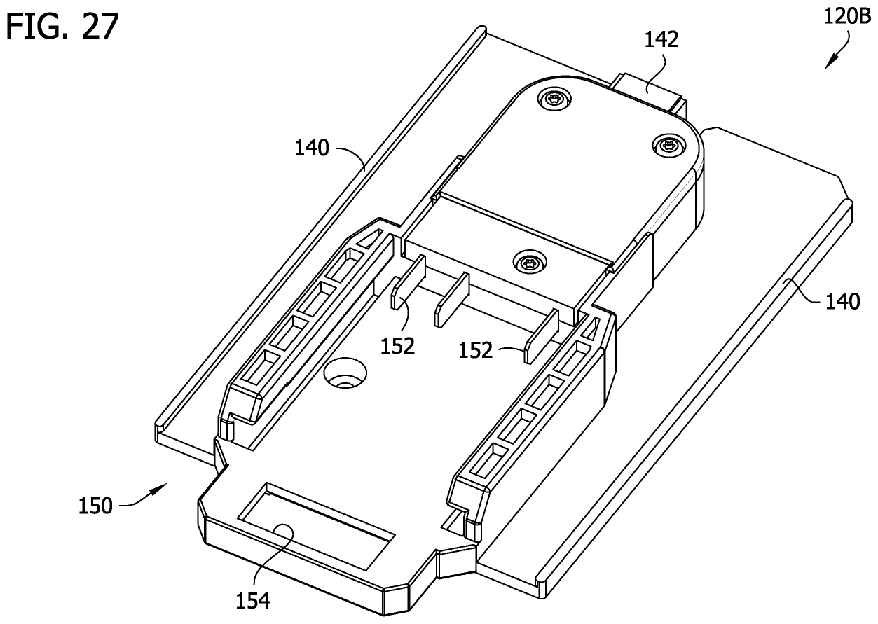

As shown in FIGS. 21-25, the spreader 10 is configured to releasably receive a battery in the battery compartment 22 to provide electrical power to the motor 60. The spreader 10 includes a kit of battery adapters 120A-120G. The spreader 10 includes an adapter receiver 130 in the battery compartment 22 configured to interchangeably receive the battery adapters. The arrangement is such that a user can select one of the battery adapters 120A-120G corresponding to a brand and/or model of battery the user desires to use, and the selected battery adapter is installed on the battery adaptor receiver 130.

In the illustrated embodiment, the adapter receiver 130 comprises adapter connection structure including opposing slide rails 132 and including an electrical connector 134. Each battery adaptor has similar receiver connection structure including first and second guides 140 (e.g., wings) and an electrical connector 142. The first and second guides 140 are configured to slide on the slide rails 132 to move the electrical connector 142 of the adapter into push-fit electrical connection with the electrical connector 134 of the receiver. The slide rails 132 retain the battery adapter in position in the battery compartment. The battery receiver 130 also includes a retainer 146 configured to retain the battery adapter in position. In the illustrated embodiment, the retainer 146 comprises a latch rotatably movable between open and retaining positions. In the retaining position, the latch 146 obstructs removal of the battery adapter from the receiver 130, and in the open position the latch permits installation/removal of the battery adapter.

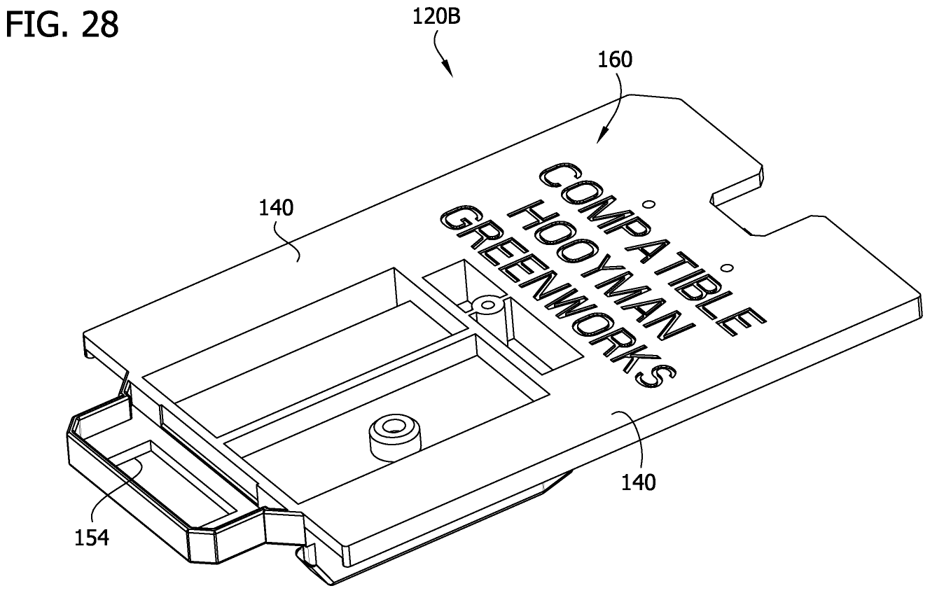

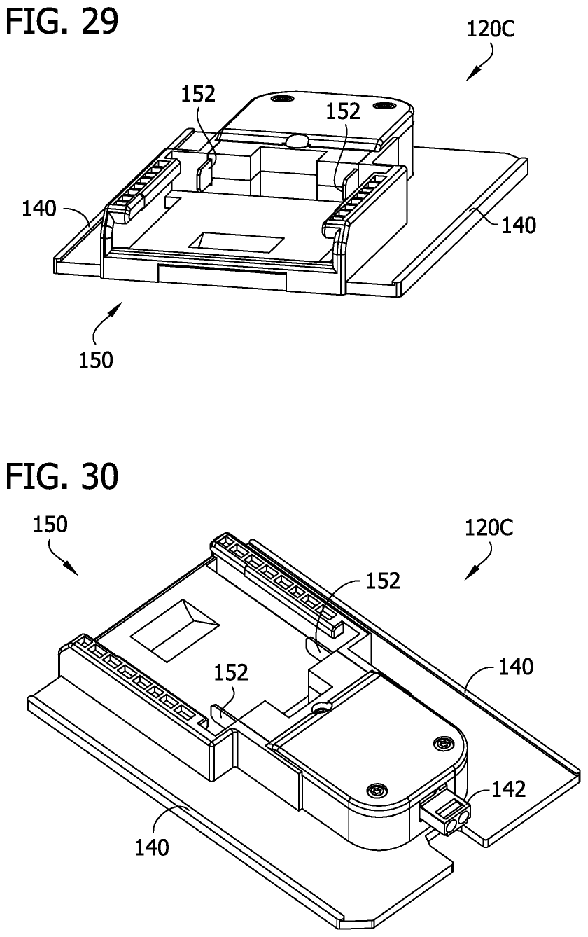

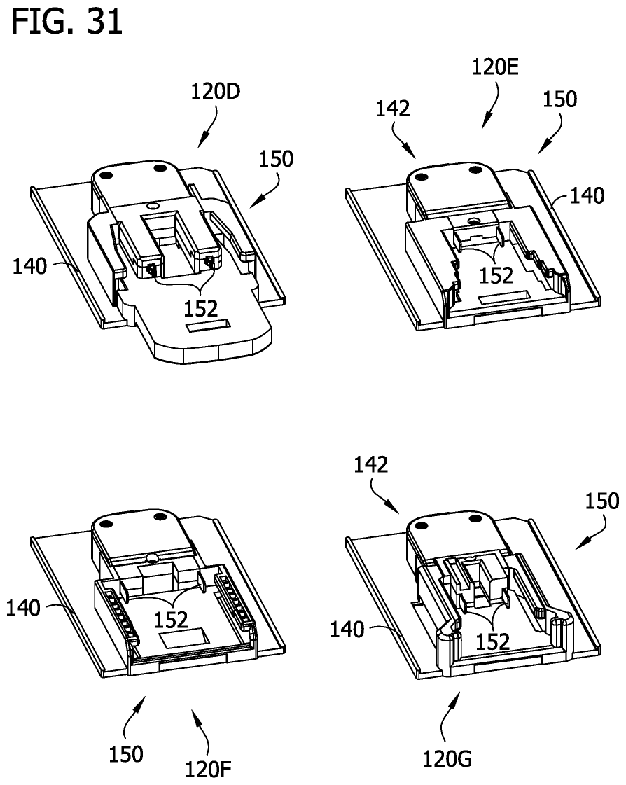

Each battery adapter 120A-120G includes a dock 150 configured to connect with a corresponding battery. Each dock 150 includes docking structure to mount the corresponding battery on the dock and includes electrical contacts 152 for forming electrical connections with the battery. The electrical contacts 152 are operatively connected (e.g., via wires) to the electrical connector 142 of the adaptor for operatively connecting the battery to the motor 60. The docking structure 150 can include slides, rails, grooves, openings, etc. sized and shaped to connect with mounting structure of the corresponding battery. For example, a battery 100 will usually slide onto the docking structure 150, and a spring-biased latch 100A (movable via button 100B) of the battery will engage a keeper 154 of the adapter to retain the battery on the docking structure. The docking structure 150 of an adapter can be of conventional construction for connecting to a conventional battery. It will be appreciated that various brands of batteries have different connection structure to require connection to tools specifically designed to receive those batteries. The battery adapters 120A-120G of the present disclosure permit batteries of different manufacturers and/or different models of batteries to be usable with the spreader 10. As shown by example in FIG. 28, each battery adapter 120 can include indicia 160 (e.g., text) indicating a brand, manufacturer, or model of battery for which the adapter is intended to be used. It will be appreciated that the battery adapter feature could be used on other types of tools (e.g., other types of tools carried by a user when operated, such as motor-driven “hand tools”) without departing from the scope of the present disclosure. Moreover, the adapter feature could be omitted from the spreader (e.g., providing instead a fixed battery dock), without departing from the scope of the present disclosure.

In use, a battery adapter 120 from the kit is chosen for use with the spreader 10. The adapter 120 is installed on the adapter receiver 130. A battery 100 can be installed on the battery dock 150 before or after installing the adapter 120 on the adapter receiver 130. When the adapter 120 is installed on the adapter receiver 130, and the battery 100 is installed on the battery dock 150 of the adapter, the battery is operatively connected to the spreader controller 92 for selectively providing electrical power to the motor 60. If the user desires to use a different brand or model of battery with the spreader 10, the user can interchange the currently installed battery adapter with a different battery adapter from the kit. The user can then use the different brand or model of battery to power the spreader. The user could choose to use a battery of the same brand as the spreader, or use a battery of a different brand, even from a different manufacturer than the spreader.

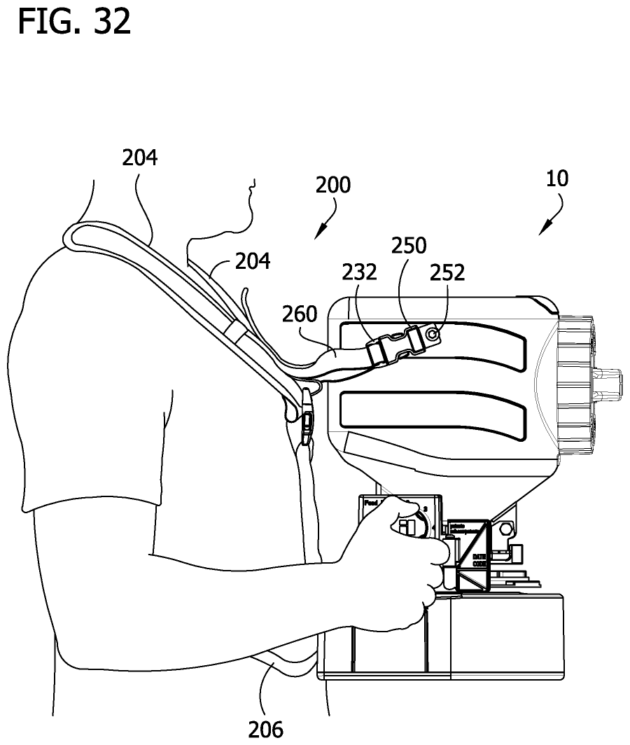

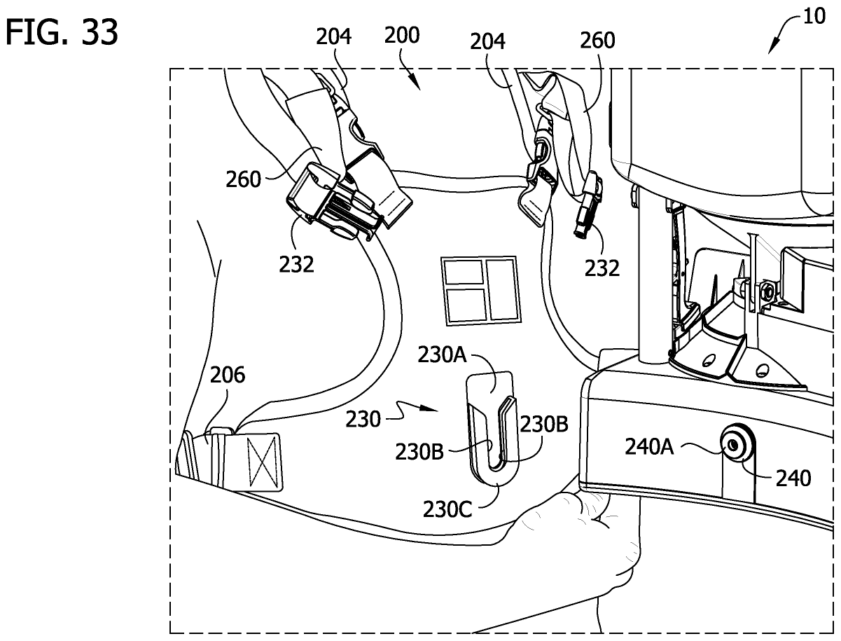

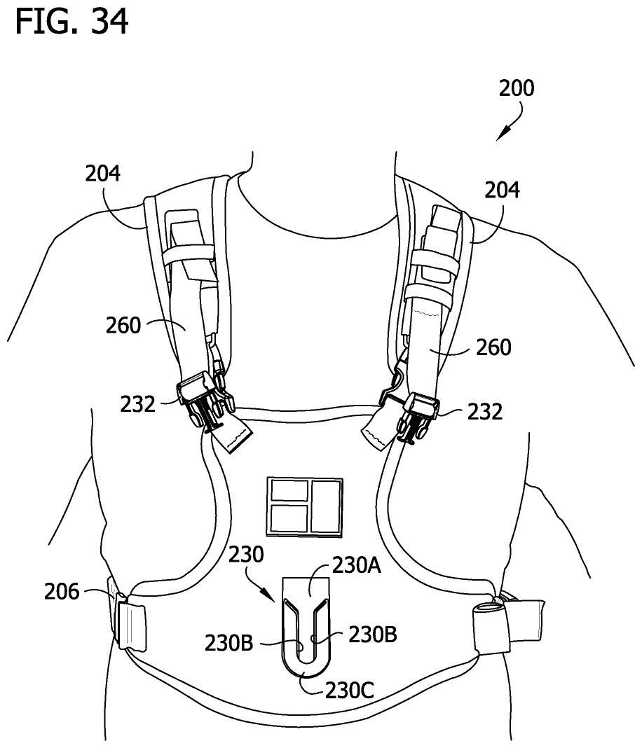

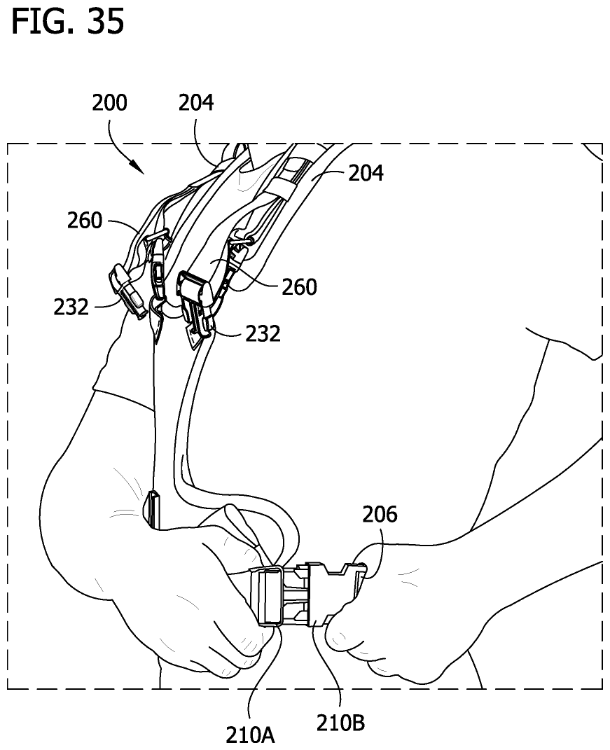

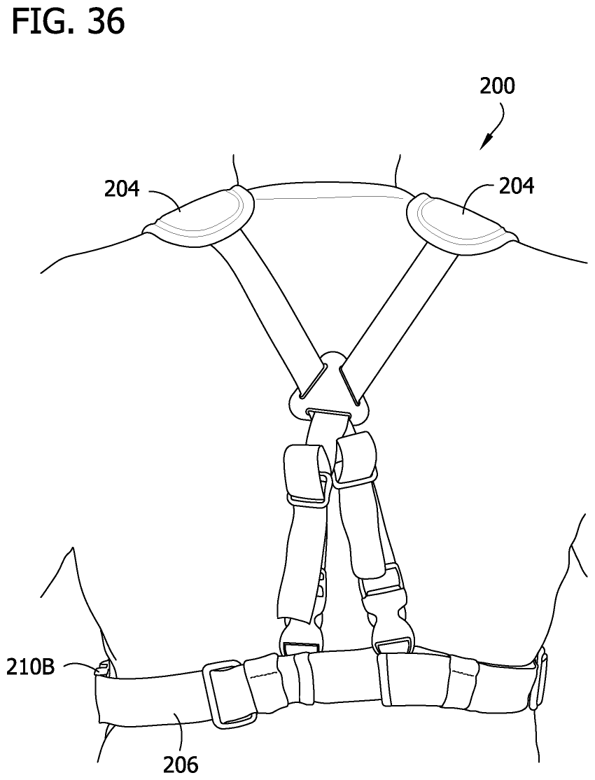

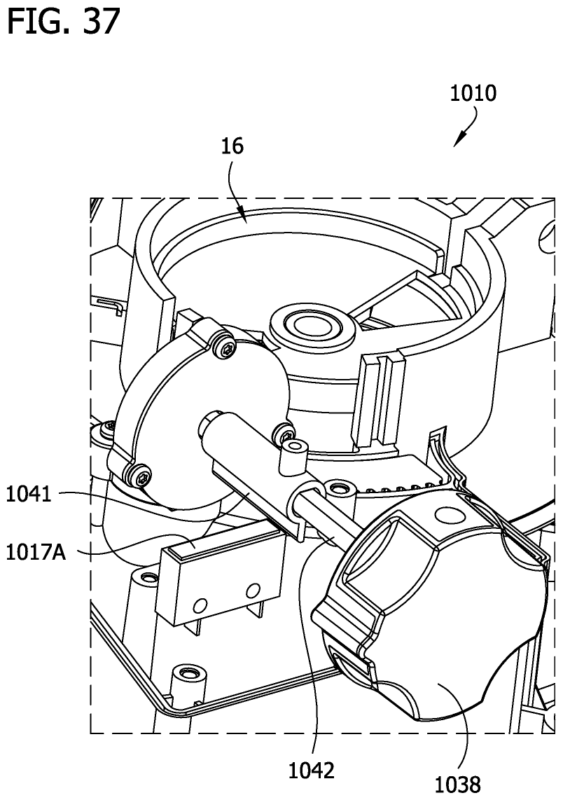

As shown in FIGS. 32-36, the spreader 10 is usable with a harness 200 configured to mount the spreader on a person. More specifically, the harness 200 is configured to be worn by the person to carry the spreader 10 on the chest of the person. While the spreader 10 is mounted on their chest, the person can operate the spreader while walking to spread granular material on an area over which the person walks. The harness 200 is configured for the person to comfortably carry the spreader 10, even when many pounds of granular material are received in the hopper 12.

The harness 200 includes a front web 202, two shoulder straps 204, and a waist belt 206. The shoulder straps 204 and waist belt 206 are connected to the front web 202. The shoulder straps 204 and waist belt 206 are also connected to each other on a rear side of the harness. The shoulder straps 204 are adjustable to change a length of the shoulder straps, and the waist belt 206 is adjustable to change the length of the waist belt, to fit people of different sizes. The waist belt 206 includes first and second snap connectors 210A, 210B (e.g., snap buckle) configured to form a snap connection to connect free ends of the waist belt to each other on one side of the user.

The user can install the harness 200 on their body before mounting the spreader 10 on the harness. The harness 200 includes mounting structure for mounting the spreader on the harness. In the illustrated embodiment, the mounting structure includes a load bearing connector 230 located to be below the user's chest (e.g., generally overlying the user's navel) when the harness is worn. The mounting structure also includes first and second upper load stabilizing connectors 232 located to be near the user's shoulders or upper chest when the harness is worn. In the illustrated embodiment, the load bearing connector 230 comprises a T-slot configured to carry most of the weight of the spreader 10 when the spreader is mounted on the harness 200. The T-slot includes an open upper end 230A configured to receive a T-post 240 of the spreader 10, and includes opposing channels 230B along which the T-post can slide downward to a closed bottom end 230C of the T-slot, where a head 240A of the T-post is captured until it is moved upward out of the T-slot. Engagement of the T-post 240 with the bottom of the T-slot 230 transfers load of the spreader to the harness 200. The upper load stabilizing connectors 232 are configured to form releasable connections with corresponding connectors 250 of the spreader. In the illustrated embodiment, the load stabilizing connectors comprise female snap connectors 232, and the connectors on the spreader 10 comprise corresponding male snap connectors 250 connected by fasteners 252 to the hopper 12. The snap connectors 232, 250 are configured to mate to form a releasable snap connection (broadly, “load stabilizing connection”). The load stabilizing connections maintain the spreader 10 in a generally upright orientation when carried by the user on the harness 200 and prevent the spreader from tipping forward or to the sides. The load stabilizing connectors 232 of the harness are connected to the shoulder straps 204 via adjustable straps 260 to permit the user to make a custom fit to their body. The harness 200 transfers load of the spreader 10 (and granular material therein) to the user that increases comfort while wearing the harness and walking with the spreader thereon. It will be appreciated that the spreader could be carried by the user in other ways. Moreover, it will be appreciated that the harness could be used to mount other types of tools (e.g., other types of battery powered tools) on the chest of a user without departing from the scope of the present disclosure.

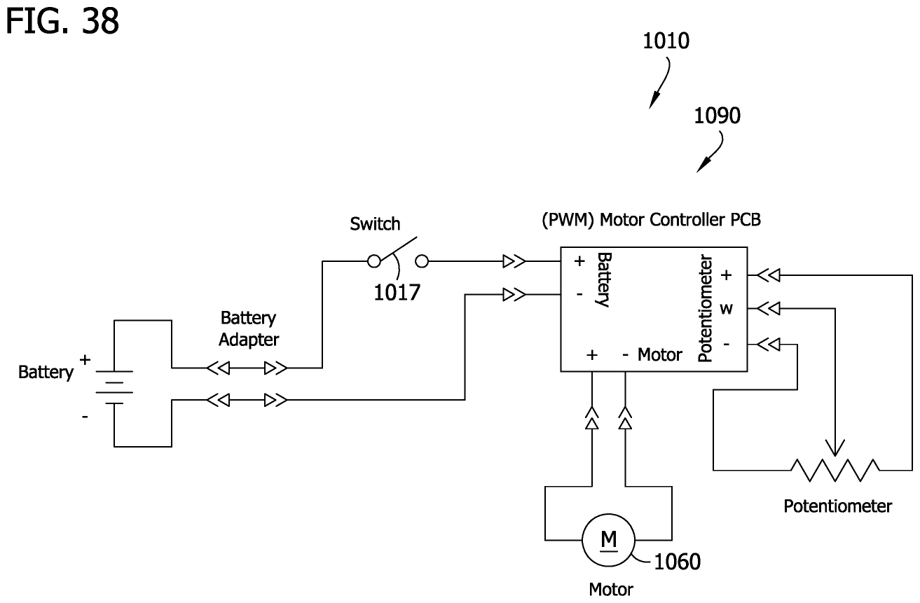

Referring to FIGS. 37 and 38, an alternative embodiment of the spreader is indicated generally by reference number 1010. In this embodiment, the spreader 1010 has the same configuration of as the spreader 10, except as described hereafter. For example, the spreader 1010 includes the control system 1090. In this embodiment, the actuator 70 and associated electronic switch 86 may be omitted, and the motor 1060 is turned on/off instead by a relay 1017 associated with the feed gate actuator 1038. The relay 1017 has a lever 1017A located to be selectively engaged by a relay actuator 1041 (broadly, “on/off actuator”) on the rotatable shaft 1042 on which the material feeder actuator 1038 is mounted. The relay lever 1017A is configured to close the circuit to turn the motor 1060 on when the lever 1017A is pressed, and is configured to open the circuit to turn the motor off when the lever is not pressed. The relay actuator 1041 is rotatable conjointly with the shaft 1042 and is configured to press the relay lever 1017A when the feed gate actuator 1038 is turned to “OFF”. The relay actuator 1041 is configured to release the relay lever 1017A when the feed gate actuator 1038 is turned to any setting other than “OFF”, such as “1”, “4”, or “6”. The arrangement is such that the motor 1060 is on and the spinner 18 is spinning whenever the material feeder 1016 is open. Accordingly, whenever material is falling onto the spinner 18, the spinner will be spinning to disperse the material. Thus, broadly speaking, the material feeder 1016 is controlled in conjunction or coordination with the spinner 18. The feed gate actuator 1038 is configured to work in coordination with the motor on/off actuator 1017.

It will be appreciated that the spreaders disclosed herein can be referred to broadly as a tool, a tool configured to be carried by a person during use, and/or a battery powered tool, without departing form the scope of the present disclosure. Moreover, one or more features disclosed herein could be used for other types of tools without departing from the scope of the present disclosure.

It will be apparent that modifications and variations are possible without departing from the scope of the appended claims.

As various changes could be made in the above constructions and methods without departing from the scope of the disclosure, it is intended that all matter contained in the above description and shown in the accompanying drawings shall be interpreted as illustrative and not in a limiting sense.

What is claimed is:

1. A broadcast spreader for spreading granular material, the broadcast spreader comprising:
a frame;
a hopper supported by the frame and configured to hold the granular material;
a spinner supported by the frame and configured to turn about a spinning axis for spreading the granular material from the hopper;
a material feeder supported by the frame and configured to feed the granular material from the hopper to the spinner; and
a feed rate actuator supported by the frame, the feed rate actuator configured to adjust the material feeder to change a rate at which the granular material is fed from the hopper to the spinner, the feed rate actuator being rotatable about an actuation axis different from the spinning axis to change the rate at which granular material is fed from the hopper to the spinner.

2. A broadcast spreader as set forth in claim 1, further comprising a driver operably connecting the feed rate actuator to the material feeder for adjusting the material feeder to change the rate at which the granular material is fed from the hopper to the spinner.

3. A broadcast spreader as set forth in claim 1, wherein the driver comprises at least a first gear.

4. A broadcast spreader as set forth in claim 3, wherein the driver comprises a second gear in mesh with the first gear and rotatable responsive to rotation of the first gear.

5. A broadcast spreader as set forth in claim 3, wherein the driver includes a rack in mesh with the first gear.

6. A broadcast spreader as set forth in claim 5, wherein the material feeder includes a feed gate movable to adjust the material feeder to change the rate at which the granular material is fed from the hopper to the spinner, the rack being operatively connected to the feed gate.

7. A broadcast spreader as set forth in claim 6, wherein the rack is movable conjointly with the feed gate.

8. A broadcast spreader as set forth in claim 1, wherein the spinner is configured to spread the granular material away from a front side of the spreader, and the feed rate actuator is located on a first lateral side of the spreader.

9. A broadcast spreader as set forth in claim 8, further comprising a motor operatively connected to the spinner for turning the spinner, and further comprising an on/off actuator configured to selectively turn the motor on and off, the on/off actuator being located on a second lateral side of the spreader opposing the first lateral side.

10. A broadcast spreader as set forth in claim 9, further comprising a spinner speed control actuator separate from the on/off actuator, the spinner speed control actuator configured to be manipulated by the person to adjust operation of the motor to adjust a speed at which the spinner spins.

11. A broadcast spreader as set forth in claim 1, wherein the broadcast spreader is configured to be carried by one person during operation of the spreader to spread the granular material.

12. A broadcast spreader configured to be carried by a person during operation of the spreader to spread granular material, the broadcast spreader comprising:
a hopper configured to hold the granular material;
a spinner configured to turn for spreading the granular material from the hopper;
a material feeder configured to feed the granular material from the hopper to the spinner; and
a motor operatively connected to the spinner to turn the spinner for spreading the granular material;
an on/off actuator configured to selectively turn the motor on and off; and
a spinner speed control actuator separate from the on/off actuator, the spinner speed control actuator configured to be manipulated by hand by the person to adjust operation of the motor to adjust a speed at which the spinner spins.

13. A broadcast spreader as set forth in claim 12, wherein the on/off actuator is configured to be manipulated by hand by the person to selectively turn the motor on and off.

14. A broadcast spreader as set forth in claim 12, wherein the spinner speed control actuator is configured to be manipulated by the user independent from manipulation of the on/off actuator for controlling the speed at which the spinner spins independently from turning the motor on and off.

15. A broadcast spreader as set forth in claim 12, wherein the spinner is configured to spread the granular material away from a front side of the spreader, and the on/off actuator is located on a first lateral side of the spreader.

16. A broadcast spreader as set forth in claim 15, wherein the spinner speed control actuator is located on a second lateral side of the spreader opposing the first lateral side.

17. A broadcast spreader as set forth in claim 16, further comprising a material feeder adjustment actuator configured to adjust the material feeder to adjust a rate at which the granular material moves from the hopper to the spinner, the material feeder adjustment actuator being located on the second lateral side of the spreader.

18. A broadcast spreader as set forth in claim 17, wherein the material feeder adjustment actuator comprises a rotatable dial.

19. A broadcast spreader system for use by a person to spread granular material, the system comprising:
a broadcast spreader comprising:
a frame;
a hopper supported by the frame and configured to hold the granular material;
a spinner supported by the frame and configured to turn for spreading the granular material from the hopper;
a material feeder supported by the frame and configured to feed the granular material from the hopper to the spinner; and
a first harness connector supported by the frame; and
a harness wearable by the person, the harness including a first shoulder strap and a second shoulder strap, the first and second shoulder straps configured to be received over left and right shoulders, respectively, of the person when the harness is worn by the person, the harness including a front web to which the first and second shoulder straps are operatively connected, the harness including a first spreader connector on the front web configured to form a first releasable connection with the first harness connector for the harness to carry the spreader.

20. A system as set forth in claim 19, wherein the broadcast spreader includes a second harness connector supported by the frame, the second harness connector being located above the first harness connector, the harness including a second spreader connector configured to form a releasable connection with the second harness connector above the first releasable connection to stabilize an orientation of the spreader with respect to the harness.
